(19) United States
(12) Patent Application Publication
(10) Pub. No.: US 2013/0333296 A1
(43) Pub. Date: Dec. 19, 2013

(54) ADJUSTABLE TEMPLATE AND A METHOD FOR OPERATING THE TEMPLATE

(71) Applicants: Declan Anthony Lyons, Newry (IE); Patrick Gerard Farrelly, Dundalk (IE); John Joseph McCormack, Newbridge (IE)

(72) Inventors: Declan Anthony Lyons, Newry (IE); Patrick Gerard Farrelly, Dundalk (IE); John Joseph McCormack, Newbridge (IE)

(73) Assignee: DECLAN ANTHONY LYONS, Newry, County Down (IE)

(21) Appl. No.: 13/878,172

(22) PCT Filed: Oct. 6, 2011
(86) PCT No.: PCT/IE11/00056

§ 371 Date: Sep. 6, 2013

(30) Foreign Application Priority Data
Oct. 6, 2010 (IE) S2010/0643

(51) Int. Cl. E04F 21/00; F16M 13/00

(52) U.S. Cl. CPC E04F 21/0007; F16M 13/00
USPC 49/506; 33/194

(57) ABSTRACT

An adjustable template for defining outer peripheral dimensions of a door comprises first and second side elements (5,6), each of which comprises an outer telescoping member (8) and an inner telescoping member (9). The first and second side elements (5,6) are coupled together by upper and lower linkage mechanisms (10,11) so that the first and second side elements (5,6) are operable between an inoperable state illustrated in FIG. 1 and an operable state illustrated in FIGS. 2 and 3 whereby the first and second side elements (5,6) define the width dimensions of the opening in which the door is to be located from the top of the opening to the bottom of the opening. The inner telescoping members (9) are urged outwardly of the outer telescoping members (8) so that the first and second side elements (5,6) extend from the saddle or floor of the opening of the door to the upper edge of the opening of the doorway.

The present invention relates to an adjustable template, and in particular, to an adjustable template for defining an outer peripheral dimension of a closure element to be located in an opening for closing thereof. The invention also relates to a method for operating the adjustable template for defining an outer peripheral dimension of a closure element.

Preparing a door for hanging in an opening of a doorway can be quite a challenging task. In general, the framework which defines the opening in a doorway in many cases can be off-square and side and top edges of the opening can be bowed. Typically, vertical side elements of the frame of the doorway may not extend exactly vertically, and furthermore, the top portion of the frame may not extend completely horizontally. Therefore, the side members and top members may not define an opening in which the side edges defined by the side members and the top edge defined by the top member are perpendicular to each other. Additionally, it is not uncommon for side and top members which define the opening of a doorway to be bowed, which can also result in lack of perpendicularity between the top member and side members. In such cases, considerable measuring up of the opening of the doorway is required, and even with extensive measuring of the opening of the doorway, a door prepared to be hung in the doorway may not accurately fit in the opening, the door may be slightly oversize in parts of the opening of the doorway, and undersize in other parts. This is undesirable.

There is therefore a need for an adjustable template which addresses this problem. There is also a need for a method for operating an adjustable template for addressing the problem.

The present invention is directed towards an adjustable template for defining an outer peripheral dimension of a closure element to be located in an opening for closing thereof. The invention is also directed towards a method for operating the adjustable template.

According to the invention there is provided an adjustable template for defining an outer peripheral dimension of a closure element to be located in an opening for closing thereof, the adjustable template being adapted for locating in the opening and comprising first and second elongated side elements, at least one linkage mechanism coupling the first and second side elements with the first and second side elements being movable relative to each other between an inoperable state adjacent each other, and an operable state spaced apart from each other with the first and second side elements defining respective opposite side edges of the opening, and a locking means for releasably locking the linkage mechanism with the first and second side elements defining the respective opposite side edges of the opening.

Preferably, the at least one linkage mechanism comprises an elongated primary link member pivotally coupled to one of the first and second side elements and slideably coupled to the other one of the first and second side elements, the primary link member being slideable longitudinally relative to the said other one of the first and second side elements, and an elongated secondary link member pivotally coupled to the said other one of the first and second side elements and pivotally coupled to the primary link member intermediate the ends thereof.

Advantageously, the spacing along the primary link member between the pivotal coupling of the primary link member to the one of the first and second side elements and the pivotal coupling of the secondary link member to the primary link member is substantially similar to the spacing between the pivotal coupling of the secondary link member to the one of the first and second side elements to which the secondary link member is pivotally coupled and the pivotal coupling of the secondary link member to the primary link member.

Ideally, the pivotal coupling of the secondary link member to the primary link member is located substantially midway along the primary link member between the opposite ends thereof.

Preferably, the locking means is co-operable with the primary link member and the one of the first and second side elements to which the primary link member is slideably coupled for releasably locking the primary link member to the said one of the first and second side elements to which the primary link member is slideably coupled.

Advantageously, the primary link member terminates in a slider element which is slideably engageable in an elongated groove extending longitudinally along the one of the first and second side elements to which the primary link member is slideably coupled.

Ideally, the locking means comprises an eccentric cam element pivotally coupled to the slider element and releasably engageable with a friction type locking action with the one of the first and second side elements to which the primary link member is slideably coupled.

Preferably, a pair of linkage mechanisms are provided, the linkage mechanisms being located adjacent respective opposite ends of the first and second side elements.

In one embodiment of the invention each one of the first and second side elements comprises an elongated first member and an elongated second member, the first and second members of the corresponding one of the first and second side elements being slideable relative to each other from a retracted state with the first and second members located side by side adjacent each other and an extended state with one of the first and second members of the corresponding one of the first and second side elements extending longitudinally outwardly of the other one of the first and second side members with the first and second side elements defining the opposite end edges of the opening.

Preferably, a securing means is provided for releasably securing the first and second members of each one of the first and second side elements in a desired state relative to each other. Advantageously, each securing means comprises a cam lock element.

Preferably, each cam lock element is located on one of the first and second members of each pair thereof, and is releasably engageable with the other one of the first and second members of the pair thereof.

Advantageously, each cam lock element is adapted to secure the first and second members of the corresponding one of the first and second side elements with a friction grip.

Advantageously, the first member of each one of the first and second side elements comprises an outer telescoping member, and the second member of each one of the first and second side elements comprises an inner telescoping member, the inner telescoping member being slideable within the outer telescoping member of the is corresponding one of the first and second side elements between the retracted state with the inner telescoping member located within the outer telescoping member, and the extended state with the inner telescoping member extending longitudinally outwardly of the outer telescoping member.

Preferably, the securing means is mounted on the outer telescoping member of each one of the first and second side elements and is releasably engageable with the inner telescoping member of the corresponding one of the first and second side elements.

In one embodiment of the invention the primary link member of each linkage mechanism is pivotally coupled to the second member of the corresponding one of the first and second side elements, and is slideably coupled to the first member of the other one of the first and second side elements. Preferably, each secondary link member is pivotally coupled to the second member of the corresponding one of the first and second side elements.

Advantageously, respective first movable abutment elements are located on one of the first and second side elements adjacent the top and bottom thereof, each first movable abutment element being urgeable sidewardly outwardly of the corresponding one of the first and second side elements for engaging one of the side edges of the opening.

Advantageously, a first adjusting means is provided for each first movable abutment element for urging the corresponding first movable abutment element inwardly and outwardly relative to the one of the first and second side elements.

Preferably, each one of the first and second side elements terminates at one end in a second movable abutment element movable longitudinally relative to the corresponding one of the first and second side elements for abutting one of the end edges of the opening.

Advantageously, a second adjusting means is provided for each second movable abutment element for urging the second movable abutment element inwardly and outwardly relative to the corresponding one of the first and second side elements.

In one embodiment of the invention a first spirit level is provided on at least one of the first and second side elements for indicating when the said one of the first and second side elements extends in a generally vertical orientation.

In another embodiment of the invention a second spirit level is provided on at least one of the first and second side elements for indicating when the said one of the first and second side elements extends in a generally horizontal orientation.

In another embodiment of the invention an elongated intermediate element is located between the first and second side elements, and each one of the first and second side elements is coupled to the intermediate element by at least one of the linkage mechanisms.

Preferably, the first and second side elements are coupled to the intermediate element by respective pairs of linkage mechanisms.

Preferably, the intermediate element comprises a pair of elongated first and second members, the first and second members being slideable relative to each other from a retracted state with the first and second members located side by side adjacent each other and an extended state with one of the first and second members extending longitudinally outwardly of the other one of the first and second members.

Advantageously, a securing means is provided for releasably securing the first and second members of the intermediate element in a desired state relative to each other.

Preferably, the first member of the intermediate element comprises an outer telescoping member, and second member of the intermediate element comprises an inner telescoping member, the inner telescoping member being slideable within the outer telescoping member of the intermediate element between the retracted state with the inner telescoping member located within the outer telescoping member, and the extended state with the inner telescoping member extending longitudinally outwardly of the outer telescoping member. Advantageously, the primary link member of at least one of the linkage mechanisms is pivotally coupled to the second member of the intermediate element, and the primary link member of another one of the linkage mechanism is slideably coupled to the first member of the intermediate element.

Preferably, the intermediate element terminates in an intermediate movable abutment element adjacent the end thereof corresponding to the ends of the first and second side elements which terminate in the second movable abutment elements, the intermediate movable abutment element being slideable longitudinally relative to the intermediate element inwardly and outwardly thereof for engaging the corresponding one of the end edges of the opening of the doorway engageable with the second movable abutment elements.

Advantageously, an intermediate adjusting means is provided for moving the intermediate movable abutment element inwardly and outwardly relative to the intermediate element.

The invention also provides a method for operating an adjustable template according to the invention for defining an outer peripheral dimension of a closure element, the method comprising locating the template in an opening which is to be closed by the closure element, and operating the first and second side elements from the inoperable state to the operable state with the first and second side elements defining respective opposite side edges of the opening, and operating the locking means for securing the first and second side elements in the operable state defining the respective side edges of the opening.

Preferably, the method further comprises operating the first and second members of the first and second side elements from the retracted state to the extended state with the opposite ends of the respective first and second side elements defining respective opposite end edges of the opening, and operating the securing means for securing the first and second members of the first and second side elements in the extended state.

Preferably, the template, with the first and second side elements locked in a desired operable state and the first and second members of the first and second side elements secured in a desired extended state, is removed from the opening and placed on a closure element, and the closure element is marked for trimming based on the dimensions defined by the first and second side elements thereof.

Advantageously, the closure element is trimmed according to the marking of the closure element.

The advantages of the invention are many. The most important advantage of the invention is that the adjustable template according to the invention facilitates the preparation of a closure element for closing an opening whereby the closure element can be relatively accurately prepared and will relatively accurately fit within the opening to be closed when prepared. A further advantage of the invention is that the adjustable template is relatively simple to operate, and requires the minimum of moving parts.

A particularly important advantage of the invention is that the template is suitable for taking up shapes of openings of both regular and irregular shape.

The invention will be more clearly understood from the following description of some preferred embodiments thereof, which are given by way of example only, with reference to the accompanying drawings, in which:

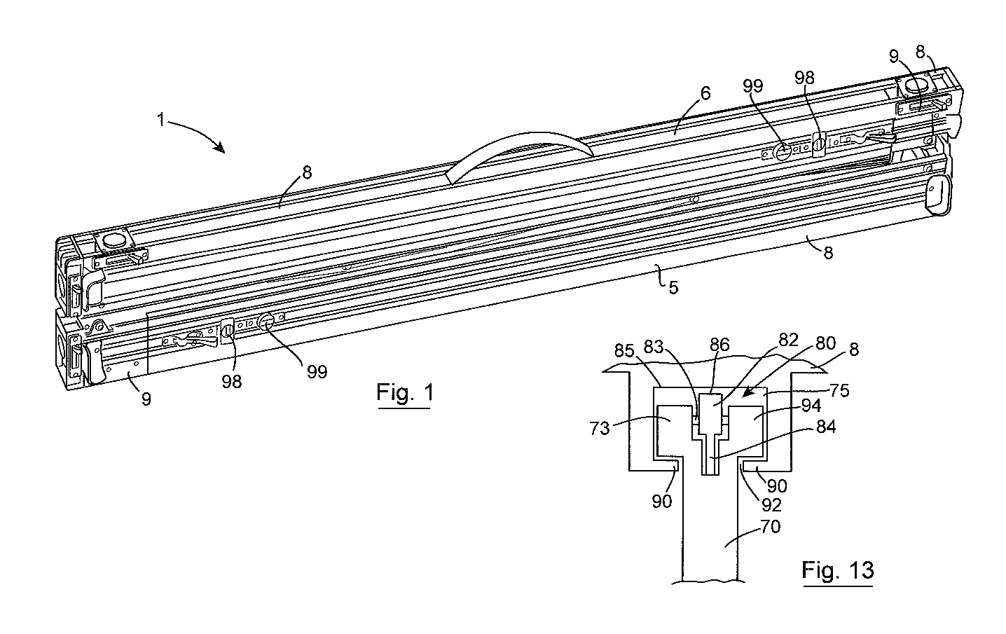

FIG. 1 is a perspective view of an adjustable template according to the invention for defining outer peripheral dimensions of a door with the adjustable template in an inoperable state,

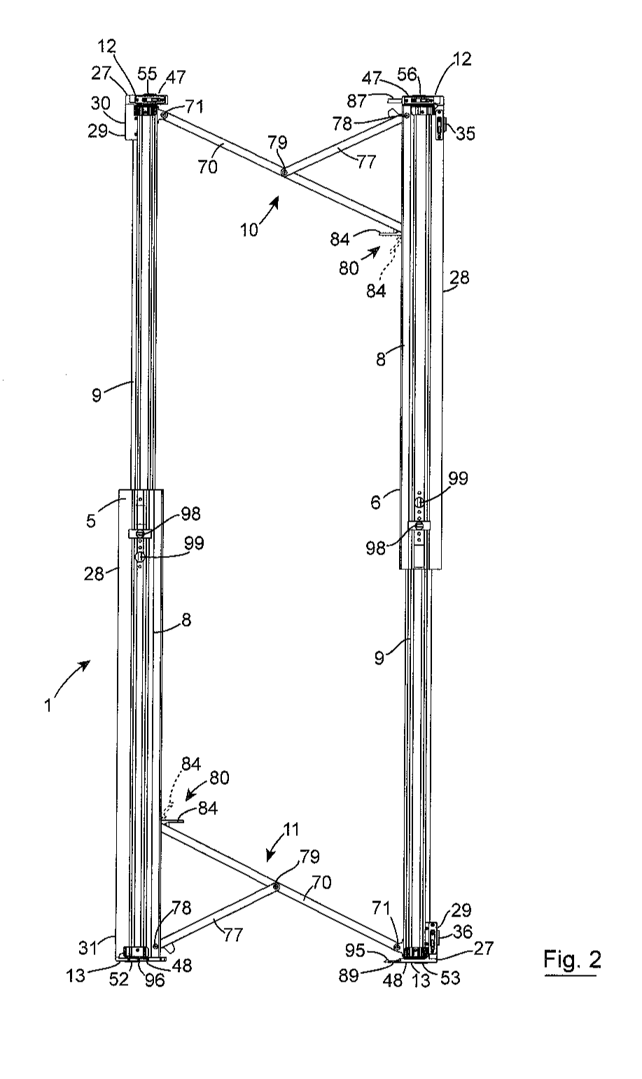

FIG. 2 is a front elevational view of the adjustable template of FIG. 1 in an operable state for defining the outer peripheral dimensions of the door,

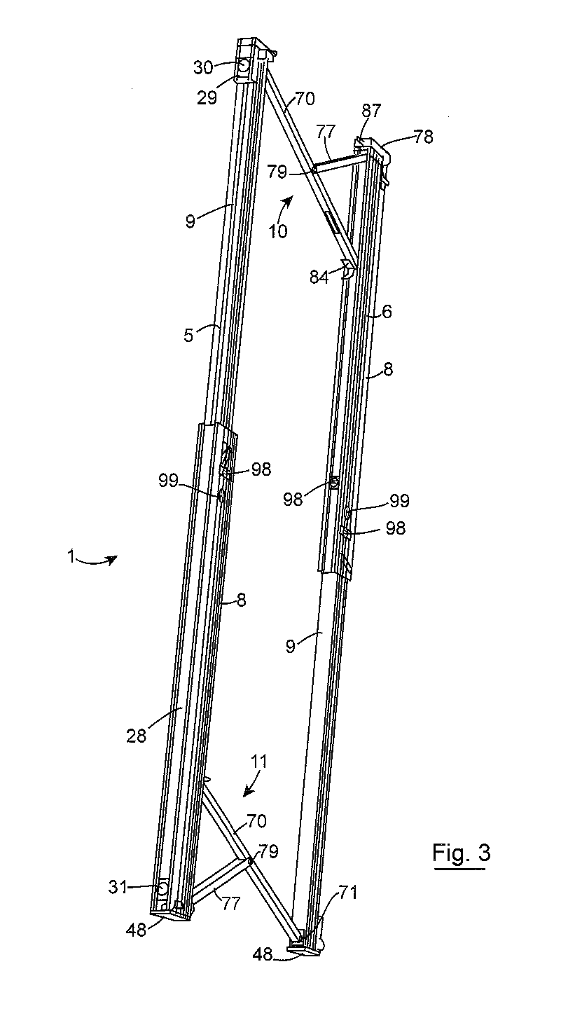

FIG. 3 is a perspective view of the adjustable template of FIG. 1 in the state of FIG. 2,

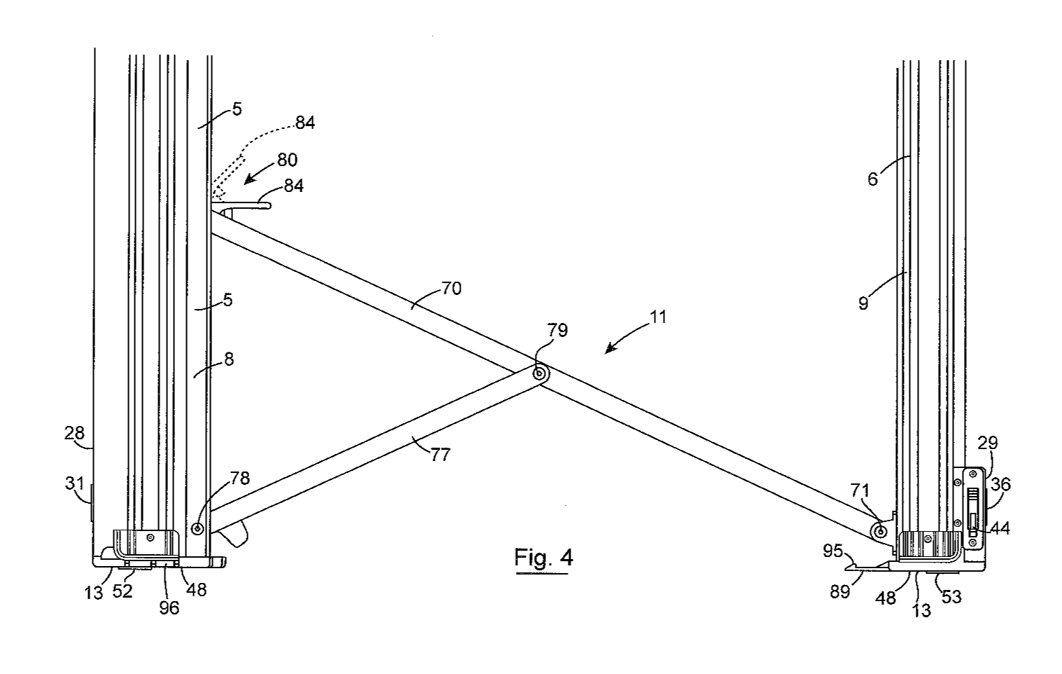

FIG. 4 is an enlarged front elevational view of a detail of the adjustable template of FIG. 1 in the state of FIG. 2,

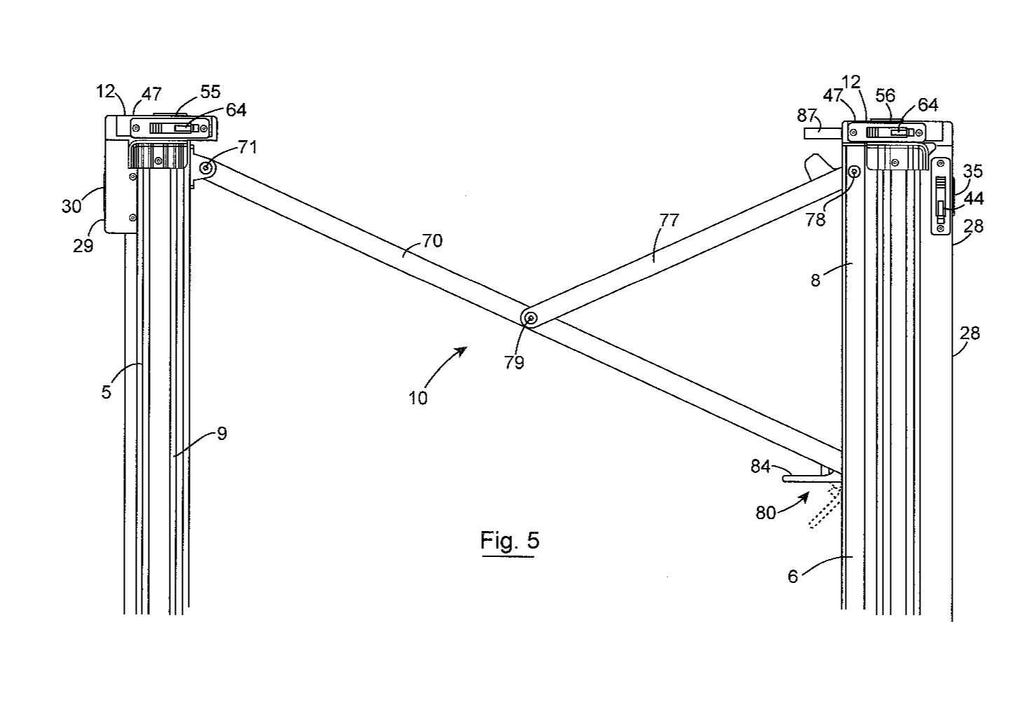

FIG. 5 is an enlarged front elevational view of a detail of the adjustable template of FIG. 1 in the state of FIG. 2,

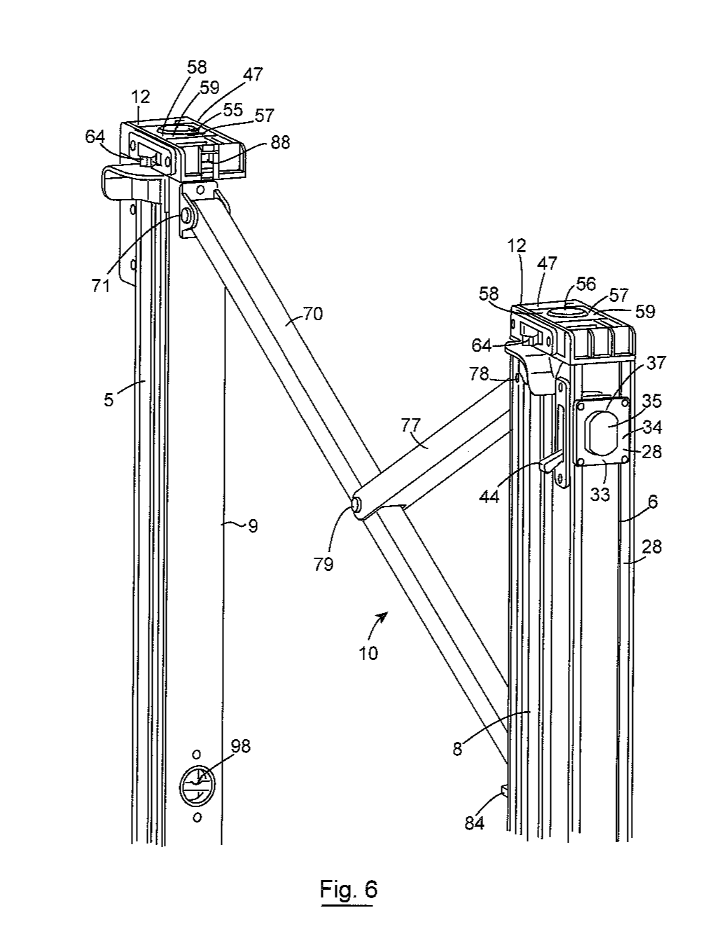

FIG. 6 is a perspective view of the portion of the adjustable template of FIG. 5 in the state of FIG. 2,

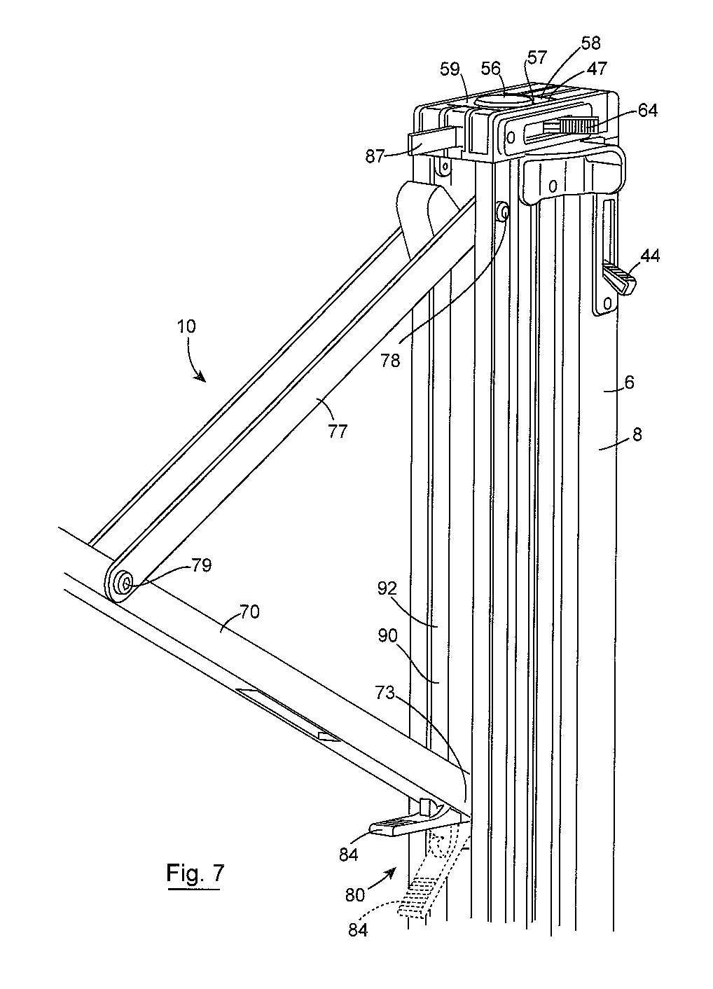

FIG. 7 is an enlarged perspective view of a detail of the adjustable template of FIG. 1,

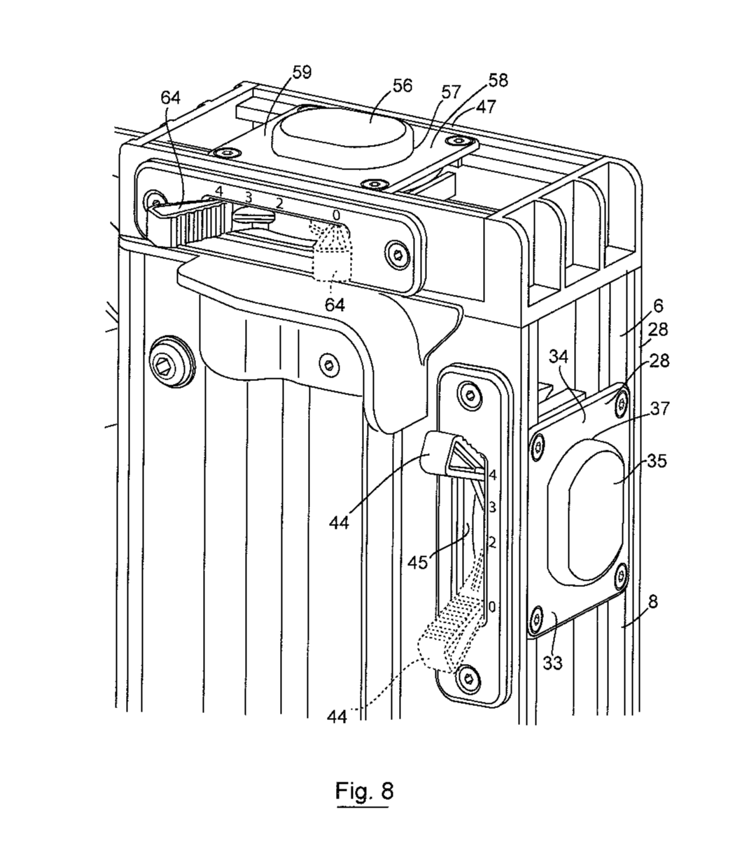

FIG. 8 is an enlarged perspective view of another detail of the adjustable template of FIG. 1,

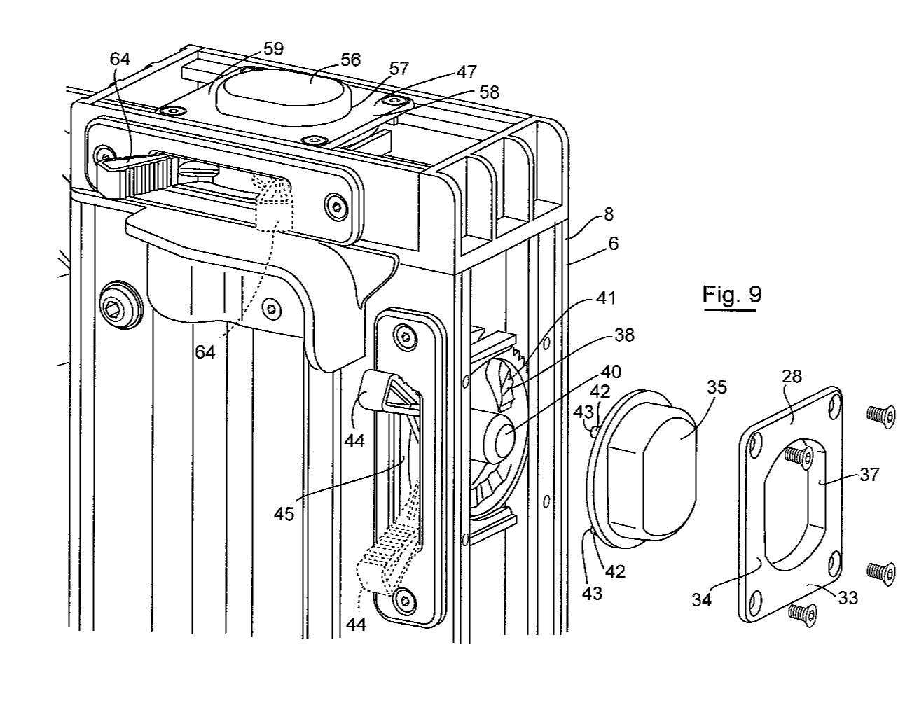

FIG. 9 is an exploded perspective view of the detail of FIG. 8 of the adjustable template of FIG. 1,

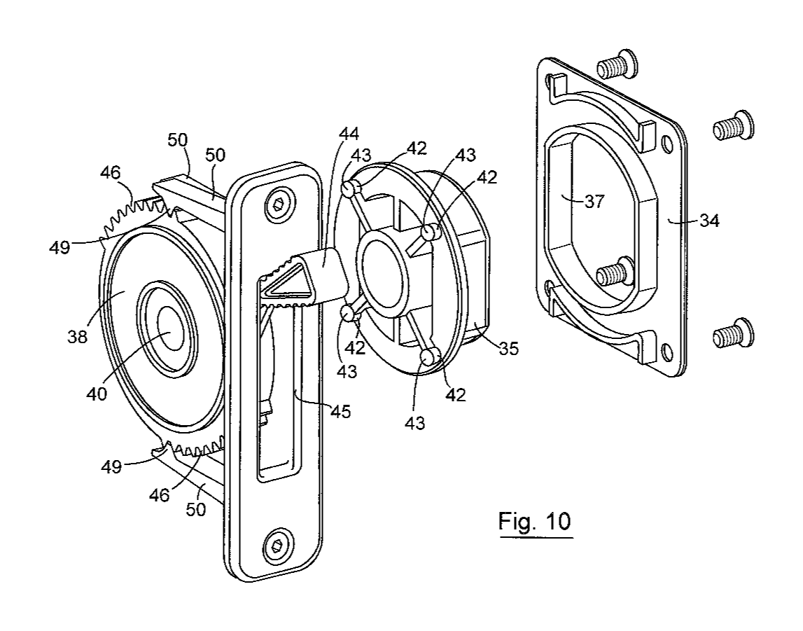

FIG. 10 is another exploded perspective view of a portion of the detail of FIG. 9 of the adjustable template of FIG. 1,

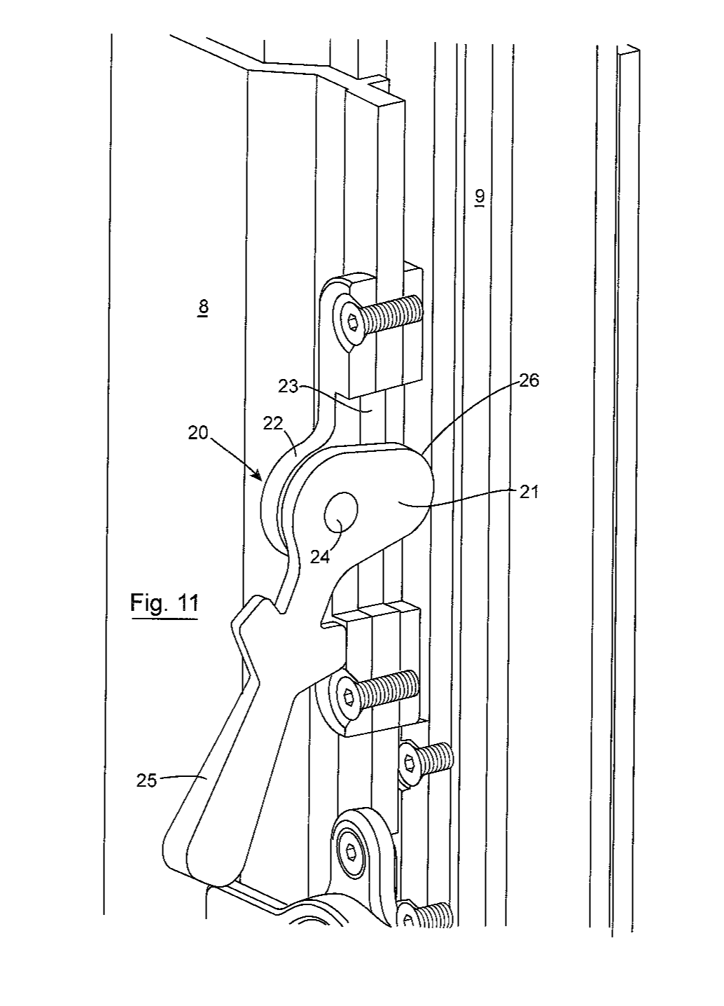

FIG. 11 is an enlarged perspective view of another detail of the adjustable template of FIG. 1,

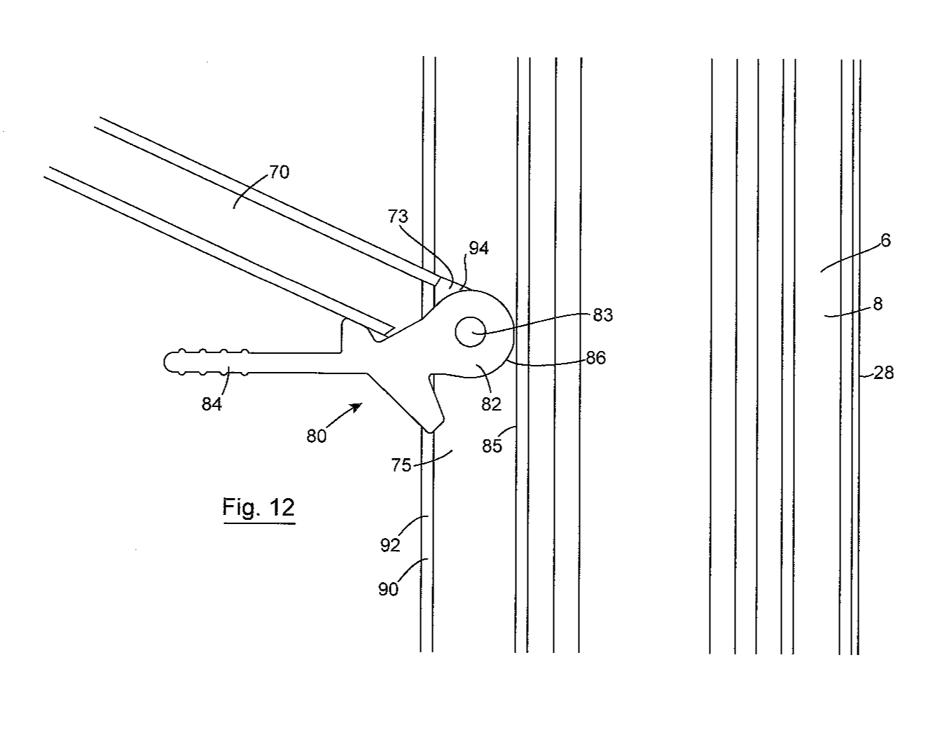

FIG. 12 is an enlarged cross-sectional side elevational view of another detail of the adjustable template of FIG. 1,

FIG. 13 is a cross-sectional plan view of a detail of the adjustable template of FIG. 1, and

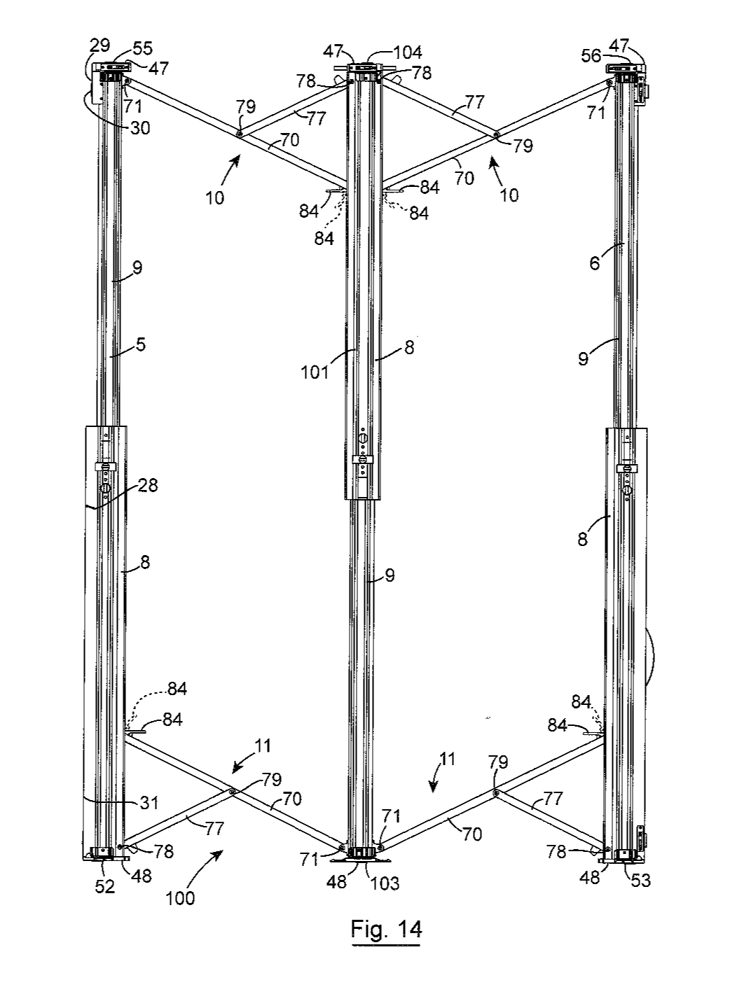

FIG. 14 is a front elevational view of an adjustable template according to another embodiment of the invention also for defining outer peripheral dimensions of a door.

Referring to the drawings and initially to FIGS. 1 to 13 thereof, there is illustrated an adjustable template according to the invention, indicated generally by the reference numeral 1, for defining outer peripheral dimensions of a closure element, in this embodiment of the invention a door (now shown) to be located in an opening (not shown) of a doorway (also not shown). However, the template 1 may be used for determining the outer dimensions of any closure element, for example, a window or the like to be located in a window opening or the like.

The template 1 comprises a pair of elongated side elements, namely, a first side element 5 and a second side element 6, each of which comprises a pair of elongated first and second members, namely, an outer telescoping member 8 and an inner telescoping member 9, respectively. The first and second side elements 5 and 6 are coupled by a pair of linkage mechanisms, namely, an upper linkage mechanism 10 and a lower linkage mechanism 11, which are similar to each other. The linkage mechanisms 10 and 11 are operable with the first and second side elements 5 and 6 in an inoperable state adjacent each other as illustrated in FIG. 1, and an operable state illustrated in FIGS. 2 and 3 with the first and second side elements 5 and 6 spaced apart from each other to define respective opposite side edges (not shown) of the opening (not shown) of the doorway (not shown). The outer and inner telescoping members 8 and 9 of the first and second side elements 5 and 6 are slideable longitudinally relative to each other from a retracted state illustrated in FIG. 1 with the inner telescoping members 9 telescoped substantially entirely within the outer telescoping members 8, and an extended state illustrated in FIGS. 2 and 3 with the inner telescoping members 9 extended outwardly from the outer telescoping members 8 so that respective opposite ends of the first and second side elements 5 and 6 define opposite end edges of the opening (not shown) of the doorway (also not shown).

Turning initially to the first and second side elements 5 and 6, a securing means comprising a cam latch 20, see FIG. 11, is pivotally mounted on each outer telescoping member 8 for releasably engaging the corresponding inner telescoping member 9 with a friction grip. Each cam latch 20 comprises an eccentric camming element 21 which is pivotally coupled between a pair of spaced apart mounting brackets 22 secured to the outer telescoping member 8 of the corresponding one of the first and second side elements 5 and 6. A pivot pin 24 extending between the mounting brackets 22 pivotally carries the camming element 21. A slot 23 in the corresponding outer telescoping member 8 between the adjacent mounting brackets 22 accommodates the camming element 21 therethrough. The camming element 21 defines a peripheral camming surface 26 which is selectively engageable with the inner telescoping member 9 of the corresponding one of the first and second side elements 5 and 6. A lever 25 extending from the camming element 21 pivots the camming element 21 on the pivot pin 24 for selectively engaging the corresponding inner telescoping member 9 with a friction grip for in turn securing the corresponding outer and inner telescoping members 8 and 9 in a desired disposition relative to each other.

Outer side faces 28 of the outer telescoping members 8 of the first and second side elements 5 and 6 are adapted to define the outer side edges of the door (not shown). The inner telescoping members 9 of the first and second side elements 5 and 6 are provided with outer side faces 29 adjacent the distal ends 27 thereof for also defining the respective opposite side edges of the door (not shown).

First stationary abutment elements 30 and 31 are provided on the first side element 5 adjacent the top end 12 and bottom end 13 thereof, respectively. The first stationary abutment element 30 is located in the outer side face 28 of the outer telescoping member 8 of the first side element 5 adjacent the bottom end 13 of the first side element 5, and the first stationary abutment element 31 is located on the outer side face 29 of the inner telescoping member 9 of the first side element 5 adjacent the top end 12 thereof. The first stationary abutment elements 30 and 31 extend from the outer side faces 28 and 29, respectively, of the first side element 5 to engage the corresponding side edge (not shown) of the opening of the doorway (not shown) for providing appropriate clearance between the corresponding side edge of the door and the side edge of the opening.

First movable abutment elements 35 and 36 are located at the top and bottom ends 12 and 13 of the second side element 6 and extend sidewardly outwardly from the outer side face 28 and the outer side face 29 of the outer and inner telescoping members 8 and 9, respectively, see FIGS. 8 to 10. The first movable abutment elements 35 and 36 are slideably mounted in bores 37 which extend through mounting plates 34, which in turn are located on the corresponding ones of the outer and inner telescoping members 8 and 9 of the second side element 6. Outer surfaces 33 of the mounting plates 34 define respective parts of the corresponding outer faces 28 and 29, so that the first movable abutment elements 35 and 36 extend through the outer faces 28 and 29, respectively. The first movable abutment elements 35 and 36 are movable sidewardly outwardly of the outer side faces 28 and 29 in order to accommodate any bowing or other imperfection in the opening of the doorway, and also to provide appropriate clearance between the door and the corresponding side edge of the opening.

First adjusting means for adjusting the first movable abutment elements 35 and 36 inwardly and outwardly in the corresponding bores 37 comprise respective first cam elements 38 which are rotatably carried on corresponding spindles 40 which in turn are located in the bores 37 and secured to the corresponding one of the outer and inner telescoping members 8 and 9. Each first cam element 38 defines a camming face 41 which in this embodiment of the invention is formed by a stepped camming face. The camming face 41 of each cam element 38 is engageable with pins 42 which extend parallel to the corresponding spindle 40 from the corresponding one of the first movable abutment elements 35 and 36. The pins 42 terminate in dome shaped distal ends 43 which define a camming face which is engageable with the camming face 41 of the corresponding first cam element 38, so that as the first cam element 38 is rotated about the spindle 40, the corresponding one of the first movable elements 35 and 36 is moved inwardly or outwardly in the corresponding bore 37, depending on the direction of rotation of the first cam element 38. A lever 44 extends from the corresponding one of the first cam elements 38 through a corresponding slot 45 in the corresponding one of the outer and inner telescoping members 8 and 9 of the second side element 6 for rotating the corresponding first cam element 38 on the corresponding spindle 40 for in turn urging the corresponding one of the first movable abutment elements 35 and 36 inwardly and outwardly in the corresponding bore 37.

Two groups of gear teeth 46 located on the periphery of each first cam element 38 are engageable with corresponding pawls 49 which are carried on resilient carrier elements 50 for releasably retaining the corresponding first cam element 38 with the corresponding one of the first movable abutment elements 35 and 36 in a desired position extending from the corresponding bore 37. The resilience of the carrier elements 50 is such as to retain the corresponding pawls 49 in engagement with the teeth 46 for retaining the corresponding first cam element 38 in a desired position, while at the same time permitting rotation of the first cam element 38 about the corresponding spindle 40 by the lever 44.

The top and bottom ends 12 and 13 of the first and second side elements 5 and 6 define respective top end faces 47 and bottom end faces 48. The top end faces 47 define the top edge (not shown) of the door (also not shown), while the bottom end faces 48 define the bottom edge (not shown) of the door (also not shown). Second stationary abutment elements 52 and 53 extend downwardly from the bottom end faces 48 of the first and second side elements 5 and 6 for abutting the bottom end edges of the opening of the doorway, which typically would be a door saddle or the ground. The second stationary abutment elements 52 and 53 extend from the bottom end faces 48 of the first and second side elements 5 and 6 a distance sufficient to provide sufficient clearance between the bottom end edge of the door and the door saddle or ground, as the case may be.

Second movable abutment elements 55 and 56 are slideable in bores 57 extending through plate members 58, which are mounted on the top ends 12 of the first and second side elements 5 and 6, see FIGS. 8 and 9. Outer surfaces 59 of the plate members 58 define parts of the top end faces 47. The second movable abutment elements 55 and 56 are movable inwardly and outwardly through the corresponding bores 57 longitudinally relative to the first and second side elements 5 and 6 for abutting the top end edge of the opening of the doorway to accommodate any bowing or imperfection in the top end edge of the opening. The second movable abutment elements 55 and 56 are substantially similar to the first movable abutment elements 35 and 36, and are movable inwardly and outwardly through the corresponding bores 57 by second adjusting means comprising second cam elements (not shown) which are similar to the first cam elements 38 and are rotatably carried on spindles (also not shown) secured to the corresponding one of the outer and inner telescoping members 8 and 9 of the second and first side elements 6 and 5, respectively. The spindles (not shown) on which the second cam elements (also not shown) are rotatable are similar to the spindles 40. Each second cam element (not shown) is provided with a camming face (also not shown) engageable with a corresponding camming face (not shown) defined by dome shaped pins, similar to those of the first movable abutment elements 35 and 36, and which in this case extend from the corresponding one of the second movable abutment elements 55 and 56. Accordingly, as the second cam element (not shown) is rotated, the corresponding one of the second movable abutment elements 55 and 56 is moved inwardly and outwardly in the bore 57 depending on the direction of rotation of the second cam element. Levers 64 extend from the second cam elements (not shown) through slots 65 in the outer and inner telescoping members 8 and 9 for rotating the second cam elements on the spindles (also not shown).

Two groups of gear teeth (not shown) are located on the periphery of each second cam element which are similar to the two groups of teeth 46 of the first cam element 38 for engaging corresponding pawls (not shown) on corresponding resilient carrier elements (also not shown) which are similar to the pawls 49 and carrier elements 50 of the first movable abutment elements 35 and 36 for releasably retaining the second cam elements (not shown) and in turn the second movable abutment elements 55 and 56 in a desired position within the corresponding bores 57.

Turning now to the linkage mechanisms 10 and 11, each linkage mechanism 10 and 11 comprises a primary link member 70, one end of which is pivotally coupled by a pivot coupling 71 to the inner telescoping member 9 of a corresponding one of the first and second side elements 5 and 6. The primary link member 70 of each linkage mechanism 10 and 11 terminates in a slider element 73 which slideably engages a corresponding groove 75 which extends longitudinally along the outer telescoping member 8 of the corresponding one of the first and second side elements 5 and 6, see FIGS. 12 and 13. A pair of returns 90 extend inwardly from opposite sides of the groove 75 and define an elongated entry slot 92 to the corresponding groove 75.

The entry slots 92 extend longitudinally of the corresponding ones of the first and second side elements 5 and 6. Each slider element 73 comprises a main body element 94 which is slideable within the corresponding groove 75, and the slot 92 accommodates the corresponding primary link member 70 from the body element 94 from the corresponding groove 75. In this embodiment of the invention the primary link member 70 of the upper linkage mechanism 10 is pivotally coupled to the inner telescoping member 9 of the first side element 5 and is slideably coupled to the outer telescoping member 8 of the second side element 6, while the primary link member 70 of the lower linkage mechanism 11 is pivotally coupled to the inner telescoping member 9 of the second side element 6 and is slideably coupled to the outer telescoping member 8 of the first side element 5.

A secondary link member 77 of each upper and lower linkage mechanism 10 and 11 is pivotally coupled to the outer telescoping member 8 of the corresponding one of the first and second side elements 5 and 6 by a pivot coupling 78, and is also pivotally coupled to the corresponding primary link member 70 intermediate the ends thereof by a pivot coupling 79. In this embodiment of the invention the pivot coupling 79 which couples the secondary link member 77 to the corresponding primary link member 70 is located midway between the respective opposite ends of the primary link member 70. Additionally, in this embodiment of the invention the spacing between the pivot couplings 78 and 79 of the secondary link member 77 is similar to the spacing between the pivot coupling 71 of the primary link member 70 to the corresponding one of the first and second side elements 5 and 6 and the pivot coupling 79 between the corresponding primary and secondary link members 70 and 77.

A locking means, in this embodiment of the invention a cam lock 80 is provided for releasably locking the upper and lower linkage mechanisms 10 and 11 with the first and second side elements 5 and 6 at the desired spacing from each other defining the side edges of the door. Each cam lock 80 comprises an eccentric cam element 82 which is pivotally carried on the corresponding slider element 73 on a pivot pin 83. Each cam element 82 defines a peripheral camming surface 86 which is engageable with a base surface 85 of the groove 75 in the outer telescoping member 8 of the corresponding one of the first and second side elements 5 and 6. The camming surface 86 of each cam element 82 on engaging the base surface 85 of the corresponding groove 75 urges the body element 94 of the corresponding slider element 73 into engagement with the return 90 of the groove 75 to thereby wedge the slider element 73 and the cam element 82 in the groove 75 between the base surface 85 of the groove 75 and the returns 90, so that the slider element 73 is releasably locked in the groove 75 with a friction grip. A lever 84 extending from each cam element 82 rotates the cam element 82 about the corresponding pivot pin 83 for engaging the camming surface 86 thereof with the base surface 85 of the corresponding groove 75, to releasably lock the corresponding slider element 73 in the groove 75.

A dowel 87 extending from the outer telescoping member 8 of the second side element 6 adjacent the top end 12 thereof is engageable with a corresponding bore 88 in the inner telescoping member 9 of the first side element 5 when the first and second side elements 5 and 6 are in the inoperable state. A resilient clip 89 terminating in an engagement element 95 extends from the inner telescoping member 9 of the second side element 6 adjacent the bottom end 13 thereof for engaging a corresponding recess 96 in the bottom face 48 of the outer telescoping member 8 of the first side element 5 for releasably retaining the first and second side elements 5 and 6 in the inoperable state.

First and second spirit levels 98 and 99, respectively, are provided on the outer telescoping members 8 of the first and second side elements 5 and 6 for indicating when the first and second side elements 5 and 6 are extending substantially vertically or substantially horizontally, respectively.

In use, in order to operate the adjustable template 1 to define the outer periphery of a door, the template 1 is initially located in the opening of the doorway in which the door is to be located. Initially the first and second side elements 5 and 6 are urged from the inoperable state to the operable state, so that the first stationary abutment elements 30 and 31 of the first side element 5 engage one of the side edges of the opening of the doorway and the second side element 6 is adjacent the opposite side edge of the opening of the doorway. The inner telescoping members 9 of the first and second side elements 5 and 6 are extended outwardly of the corresponding outer telescoping members 8, so that with the second stationary abutment elements 52 and 53 resting on the door saddle or ground, as the case may be, the top end faces 47 of the first and second side elements 5 and 6 are adjacent the top end edge of the opening of the doorway. With the inner and outer telescoping members of the first and second side elements 5 and 6 so located in the opening of the doorway, the cam latches 20 are operated for securing the outer and inner telescoping members 8 and 9 of the first and second side elements 5 and 6 in the desired extended state relative to each other. The cam locks 80 are then operated for securing the slider elements 73 of the primary link members 70 in the grooves 75 of the outer telescoping members 8 of the corresponding ones of the first and second side elements 5 and 6, with the first and second side elements 5 and 6 spaced apart from each other and substantially defining the width of the opening of the doorway.

Thereafter, fine adjustment of the template 1 in the opening of the doorway is carried out by operating the levers 44 to urge the first movable abutment elements 35 and 36 into engagement with the adjacent side edge of the opening of the doorway. The levers 64 are operated to urge the second movable abutment elements 55 and 56 into engagement with the top end edge of the opening of the doorway. The first and second movable abutment elements 35, 36, 55 and 56 accommodate any bowing or other imperfections in the side and top end edges of the opening of the doorway. With the template 1 so adjusted, the template 1 is removed from the opening of the doorway and placed on the door with the door lying substantially flat and horizontal. The door is thus marked by pencil or other suitable means using the outer side faces 28 and 29 of the first and second side elements 5 and 6 to define the side edges of the door and the top and bottom end faces 47 and 48 to define the top and bottom edges of the door. Thereafter, the door is trimmed according to the peripheral dimensions derived from the template 1, and the door is then hung in the opening 3 of the doorway 4.

Referring now to FIG. 14, there is illustrated a template according to another embodiment of the invention, indicated generally by the reference numeral 100. The template 100 is substantially similar to the template 1 and similar components are identified by the same reference numerals. The only difference between the template 100 and the template 1 is that the template 100 is provided with an intermediate element 101. The intermediate element 101 is located between the first and second side elements 5 and 6, and is coupled to the first and second side elements 5 and 6 by respective pairs of upper and lower linkage mechanisms 10 and 11, which are similar to the upper and lower linkage mechanisms 10 and 11 of the template 1. The intermediate element 101 comprises outer and inner telescoping members 8 and 9, which are similar to the outer and inner telescoping members 8 and 9 of the first and second side elements 5 and 6 of the template 1. The primary link members 70 of the upper linkage mechanisms 10 are pivotally coupled to the inner telescoping members 9 of the corresponding ones of the first and second side elements 5 and 6. The primary link members 70 of the upper linkage mechanisms 10 are slideably coupled to the outer telescoping member 8 of the intermediate element 101. The secondary link members 77 of the upper linkage mechanisms 10 are pivotally coupled to the outer telescoping member 8 of the intermediate element 101. The primary link members 70 of the lower linkage mechanisms 11 are pivotally coupled to the inner telescoping member 9 of the intermediate element 101, and are slideably coupled to the outer telescoping members 8 of the first and second side elements 5 and 6. The secondary link members 77 of the lower linkage mechanisms 11 are pivotally coupled to the outer telescoping members 9 of the first and second side elements 5 and 6. Additionally, the intermediate element 101 is provided with a second stationary abutment element 103 and a second movable abutment elements 104, which are similar to the second stationary and second movable abutment elements 52 and 53, and 55 and 56, respectively, of the template 1.

Otherwise, the template 100 and its use is similar to the template 1, and its use is likewise similar to that of the template 1. The template 100 is particularly suitable for determining the outer periphery of a door suitable for a doorway with a relatively wide opening.

It is envisaged that the first and second stationary elements could be provided by screws which would be located in threaded bores in the corresponding first, second and intermediate elements, and in which case the screws could be adjustable to provide further adjustment.

1.-35. (canceled)

36. An adjustable template for defining an outer peripheral dimension of a closure element to be located in an opening for closing thereof, the adjustable template being adapted for locating in the opening and comprising first and second elongated side elements, at least one linkage mechanism coupling the first and second side elements with the first and second side elements being movable relative to each other between an inoperable state adjacent each other, and an operable state spaced apart from each other with the first and second side elements defining respective opposite side edges of the opening, and a locking means for releasably locking the linkage mechanism with the first and second side elements defining the respective opposite side edges of the opening.

37. An adjustable template as claimed in claim 36 in which the at least one linkage mechanism comprises an elongated primary link member pivotally coupled to one of the first and second side elements and slideably coupled to the other one of the first and second side elements, the primary link member being slideable longitudinally relative to the said other one of the first and second side elements, and an elongated secondary link member pivotally coupled to the said other one of the first and second side elements and pivotally coupled to the primary link member intermediate the ends thereof.

38. An adjustable template as claimed in claim 37 in which the spacing along the primary link member between the pivotal coupling of the primary link member to the one of the first and second side elements and the pivotal coupling of the secondary link member to the primary link member is substantially similar to the spacing between the pivotal coupling of the secondary link member to the one of the first and second side elements to which the secondary link member is pivotally coupled and the pivotal coupling of the secondary link member to the primary link member, and preferably, the pivotal coupling of the secondary link member to the primary link member is located substantially midway along the primary link member between the opposite ends thereof, and advantageously, the locking means is co-operable with the primary link member and the one of the first and second side elements to which the primary link member is slideably coupled for releasably locking the primary link member to the said one of the first and second side elements to which the primary link member is slideably coupled.

39. An adjustable template as claimed in claim 37 in which the primary link member terminates in a slider element which is slideably engageable in an elongated groove extending longitudinally along the one of the first and second side elements to which the primary link member is slideably coupled, and preferably, the locking means comprises an eccentric cam element pivotally coupled to the slider element and releasably engageable with a friction type locking action with the one of the first and second side elements to which the primary link member is slideably coupled.

40. An adjustable template as claimed in claim 36 in which a pair of linkage mechanisms are provided, the linkage mechanisms being located adjacent respective opposite ends of the first and second side elements.

41. An adjustable template as claimed in claim 36 in which each one of the first and second side elements comprises an elongated first member and an elongated second member, the first and second members of the corresponding one of the first and second side elements being slideable relative to each other from a retracted state with the first and second members located side by side adjacent each other and an extended state with one of the first and second members of the corresponding one of the first and second side elements extending longitudinally outwardly of the other one of the first and second side members with the first and second side elements defining the opposite end edges of the opening.

42. An adjustable template as claimed in claim 41 in which a securing means is provided for releasably securing the first and second members of each one of the first and second side elements in a desired state relative to each other.

43. An adjustable template as claimed in claim 42 in which each securing means comprises a cam lock element, and preferably, each cam lock element is located on one of the first and second members of each pair thereof, and is releasably engageable with the other one of the first and second members of the pair thereof, and advantageously, each cam lock element is adapted to secure the first and second members of the corresponding one of the first and second side elements with a friction grip, and preferably, the first member of each one of the first and second side elements comprises an outer telescoping member, and the second member of each one of the first and second side elements comprises an inner telescoping member, the inner telescoping member being slideable within the outer telescoping member of the corresponding one of the first and second side elements between the retracted state with the inner telescoping member located within the outer telescoping member, and the extended state with the inner telescoping member extending longitudinally outwardly of the outer telescoping member, and advantageously, the securing means is mounted on the outer telescoping member of each one of the first and second side elements and is releasably engageable with the inner telescoping member of the corresponding one of the first and second side elements.

44. An adjustable template as claimed in claim 41 in which the primary link member of each linkage mechanism is pivotally coupled to the second member of the corresponding one of the first and second side elements, and is slideably coupled to the first member of the other one of the first and second side elements.

45. An adjustable template as claimed in claim 41 in which each secondary link member is pivotally coupled to the second member of the corresponding one of the first and second side elements.

46. An adjustable template as claimed in claim 36 in which respective first movable abutment elements are located on one of the first and second side elements adjacent the top and bottom thereof, each first movable abutment element being urgeable sidewardly outwardly of the corresponding one of the first and second side elements for engaging one of the side edges of the opening, and preferably, a first adjusting means is provided for each first movable abutment element for urging the corresponding first movable abutment element inwardly and outwardly relative to the one of the first and second side elements.

47. An adjustable template as claimed in claim 36 in which each one of the first and second side elements terminates at one end in a second movable abutment element movable longitudinally relative to the corresponding one of the first and second side elements for abutting one of the end edges of the opening, and preferably, a second adjusting means is provided for each second movable abutment element for urging the second movable abutment element inwardly and outwardly relative to the corresponding one of the first and second side elements.

48. An adjustable template as claimed in claim 36 in which a first spirit level is provided on at least one of the first and second side elements for indicating when the said one of the first and second side elements extends in a generally vertical orientation, and preferably, a second spirit level is provided on at least one of the first and second side elements for indicating when the said one of the first and second side elements extends in a generally horizontal orientation.

49. An adjustable template as claimed in claim 36 in which an elongated intermediate element is located between the first and second side elements, and each one of the first and second side elements is coupled to the intermediate element by at least one of the linkage mechanisms, and preferably, the first and second side elements are coupled to the intermediate element by respective pairs of linkage mechanisms, and advantageously, the intermediate element comprises a pair of elongated first and second members, the first and second members being slideable relative to each other from a retracted state with the first and second members located side by side adjacent each other and an extended state with one of the first and second members extending longitudinally outwardly of the other one of the first and second members, and preferably, a securing means is provided for releasably securing the first and second members of the intermediate element in a desired state relative to each other.

50. An adjustable template as claimed in claim 49 in which the first member of the intermediate element comprises an outer telescoping member, and second member of the intermediate element comprises an inner telescoping member, the inner telescoping element being slideable within the outer telescoping member of the intermediate member between the retracted state with the inner telescoping member located within the outer telescoping member, and the extended state with the inner telescoping member extending longitudinally outwardly of the outer telescoping member.

51. An adjustable template as claimed in claim 49 in which the primary link member of at least one of the linkage mechanisms is pivotally coupled to the second member of the intermediate element, and the primary link member of another one of the linkage mechanism is slideably coupled to the first member of the intermediate element.

52. An adjustable template as claimed in claim 49 in which the intermediate element terminates in an intermediate movable abutment element adjacent the end thereof corresponding to the ends of the first and second side elements which terminate in the second movable abutment elements, the intermediate movable abutment element being slideable longitudinally relative to the intermediate element inwardly and outwardly thereof for engaging the corresponding one of the end edges of the opening of the doorway engageable with the second movable abutment elements, and preferably, an intermediate adjusting means is provided for moving the intermediate movable abutment element inwardly and outwardly relative to the intermediate element.

53. A method for operating an adjustable template as claimed in claim 36 for defining an outer peripheral dimension of a closure element, the method comprising locating the template in an opening which is to be closed by the closure element, and operating the first and second side elements from the inoperable state to the operable state with the first and second side elements defining respective opposite side edges of the opening, and operating the locking means for securing the first and second side elements in the operable state defining the respective side edges of the opening.

54. A method as claimed in claim 53 further comprising operating the first and second members of the first and second side elements from the retracted state to the extended state with the opposite ends of the respective first and second side elements defining respective opposite end edges of the opening, and operating the securing means for securing the first and second members of the first and second side elements in the extended state.

55. A method as claimed in claim 53 in which the template, with the first and second side elements locked in a desired operable state and the first and second members of the first and second side elements secured in a desired extended state, is removed from the opening and placed on a closure element, and the closure element is marked for trimming based on the dimensions defined by the first and second side elements thereof, and advantageously, the closure element is trimmed according to the marking of the closure element.
